(19) United States
(12) Patent Application Publication
(10) Pub. No.: US 2016/0348734 A1
(43) Pub. Date: Dec. 1, 2016

(54) DRIVE MODULE WITH A CLUTCH HAVING TORQUE-TRANSMITTING FEATURES CONFIGURED TO RESIST AXIAL MOVEMENT OF A CLUTCH COLLAR

(71) Applicant: E-AAM DRIVELINE SYSTEMS AB, Trollhättan (SE)

(72) Inventor: Erik J. STEN, Trollhättan (SE)

(73) Assignee: e-AAM Driveline Systems AB, Trollhättan (SE)

(21) Appl. No.: 15/116,727

(22) PCT Filed: Feb. 11, 2015
(86) PCT No.: PCT/IB2015/051034

§ 371 Date: Aug. 4, 2016

Related U.S. Application Data
(60) Provisional application No. 61/939,441, filed on Feb. 13, 2014.

(51) Int. Cl. F16D 11/10

(52) U.S. Cl. CPC F16D 11/10; F16D 2011/002

(57) ABSTRACT

A power transmitting component having a clutch with a clutch collar that is mounted on a shaft and movable between a first position, to thereby rotationally couple the shaft to another rotary component, and a second position. The clutch collar has first clutch teeth parts, which are engaged to teeth on the shaft, and second clutch teeth parts that are engagable to teeth on the rotary component. The first clutch teeth parts are configured to cooperate with the teeth on the shaft to inhibit movement of the clutch collar from the first position toward the second position so as to resist disengagement of the second clutch teeth parts from the teeth on the rotary component.

### FIELD

The present disclosure relates to a drive module with a clutch having torque transmitting features configured to resist axial movement of a clutch collar.

### BACKGROUND

This section provides background information related to the present disclosure which is not necessarily prior art.

One type of clutch employs a sliding collar that can be moved between two positions to selectively couple a first shaft to a second shaft. Commonly, the collar is non-rotatably but axially slidably coupled to a first shaft member via a set of mating splines or longitudinally extending teeth. It would be desirable to form the splines or other torque transmitting features such that they cooperated to resist engagement and/or disengagement of the sliding collar to/from the second shaft.

### SUMMARY

This section provides a general summary of the disclosure, and is not a comprehensive disclosure of its full scope or all of its features.

In one form, the present teachings provide a power transmitting component that includes first, second and third rotary members and a clutch collar. The first rotary member has a plurality of first teeth, each of which having a first engaging portion, a second engaging portion, and a first transition portion that is disposed between the first and second engaging portions. Each first engaging portion has a first flank that extends further from a midpoint of a corresponding one of the first teeth with decreasing distance to the first transition portion. Each second engaging portion has a second flank that extends further from a midpoint of an associated one of the first teeth with decreasing distance to the first transition portion. The second rotary member has a plurality of second teeth. The third rotary member has a plurality of third teeth. The clutch collar has a plurality of clutch teeth. Each clutch tooth has a tooth member and a stop member that are integrally formed with one another. Each stop member has a third engaging portion, a fourth engaging portion and a second transition portion that is disposed between the third and fourth engaging portions. Each third engaging portion has a third flank that extends further from a midpoint of a corresponding one of the clutch teeth with decreasing distance to the second transition portion. Each fourth engaging portion has a fourth flank that extends further from a midpoint of an associated one of the clutch teeth with decreasing distance to the second transition portion. The clutch collar is movable between a first position, a second position and a third position. When the clutch collar is in the first position, the second flanks of the second engaging portions engage the third flanks of the third engaging portions and the tooth members are engaged to the second teeth to thereby transmit rotary power between the first rotary member, the clutch collar and the second rotary member while the second and third flanks cooperate to resist movement of the clutch collar in a direction away from the second rotary member. When the clutch collar is in the third position, the first flanks of the first engaging portions engage the fourth flanks of the fourth engaging portions and the tooth members are engaged to the third teeth to thereby transmit rotary power between the first rotary member, the clutch collar and the third rotary member while the first and fourth flanks cooperate to resist movement of the clutch collar in a direction away from the first rotary member. When the clutch collar is in the second position, the clutch teeth are not engaged to the second or third teeth.

In another form, the present teachings provide a power transmitting component that includes first and second rotary members and a clutch collar. The first rotary member has a plurality of first teeth, each of which having a first engaging portion and a first transition portion adjacent to the first engaging portion. Each first engaging portion has a first flank that extends further from a midpoint of a corresponding one of the first teeth with decreasing distance to the first transition portion. The second rotary member has a plurality of second teeth. The clutch collar has a plurality of clutch teeth, each of which having a tooth member and a stop member that are integrally formed with one another. Each stop member has a second engaging portion and a second transition portion adjacent to the second engaging portion. Each second engaging portion has a second flank that extends further from a midpoint of a corresponding one of the clutch teeth with decreasing distance to the second transition portion. The clutch collar is movable between a first position and a second position. When the clutch collar is in the first position, the first flanks of the first engaging portions engage the second flanks of the second engaging portions and the tooth members are engaged to the first teeth to thereby transmit rotary power between the first rotary member, the clutch collar and the first rotary member, while the first and second flanks cooperate to resist movement of the clutch collar in a direction away from the first rotary member. When the clutch collar is in the second position, the clutch teeth are not engaged to the second teeth.

In still another form, the present teachings provide a power transmitting component that includes first and second rotary members and a clutch collar. The first rotary member has a plurality of first teeth that include a first engaging portion. The second rotary member has a plurality of second teeth. The clutch collar has a plurality of clutch teeth, each of which having a tooth member and a stop member that are integrally formed with one another. Each stop member has a second engaging portion with a second flank that extends further from a midpoint of a corresponding one of the clutch teeth with decreasing distance to the tooth member. Each first engaging portion has a first flank that extends further from a midpoint of an associated one of the first teeth with decreasing distance to the second rotary member. The clutch collar is movable between a first position and a second position. When the clutch collar is in the first position, the first flanks of the first engaging portions engage the second flanks of the second engaging portions and the tooth members are engaged to the second teeth to thereby transmit rotary power between the first rotary member, the clutch collar and the second rotary member while the first and second flanks cooperate to resist movement of the clutch collar in a direction away from the second rotary member.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a sectional view of an exemplary drive module having a power transmitting component or clutch mechanism constructed in accordance with the teachings of the present disclosure;

FIG. 2 is a perspective view of a portion of the drive module of FIG. 1 illustrating a clutch collar of the clutch mechanism in a first position;

FIG. 3 is a schematic illustration of a portion of the drive module of FIG. 1 illustrating the clutch collar in the first position such that rotary power is not transmitted through the clutch mechanism;

FIG. 4 is a perspective view similar to that of FIG. 2 but illustrating the clutch collar in a second position;

FIG. 5 is a schematic illustration similar to that of FIG. 3 but illustrating the clutch collar in the second position such that rotary power is transmitted through the clutch mechanism;

FIG. 6 is a schematic illustration of a portion of another drive module constructed in accordance with the teachings of the present disclosure;

FIGS. 7 and 8 are schematic illustrations of drive modules similar to those of FIGS. 1 and 6, respectively, in which the tips of various selectively meshable teeth are contoured to promote engagement;

FIG. 9 is a partly sectioned, top plan view of a portion of another drive module constructed in accordance with the teachings of the present disclosure, the view depicting a clutch collar in a (second) position in which a tooth member of the clutch collar is disengaged from a tooth on an intermediate output gear;

FIG. 10 is a perspective view of a portion of the drive module of FIG. 9, the view illustrating the drive portion of an intermediate shaft in more detail;

FIG. 11 is a perspective view of a portion of the drive module of FIG. 9, the view illustrating the clutch collar in more detail; and

FIG. 12 is a view similar to that of FIG. 9 but depicting the clutch collar in a (first) position in which the tooth member of the clutch collar is engaged to the tooth on the intermediate output gear.

Corresponding reference numerals indicate corresponding parts throughout the several views of the drawings.

### DETAILED DESCRIPTION

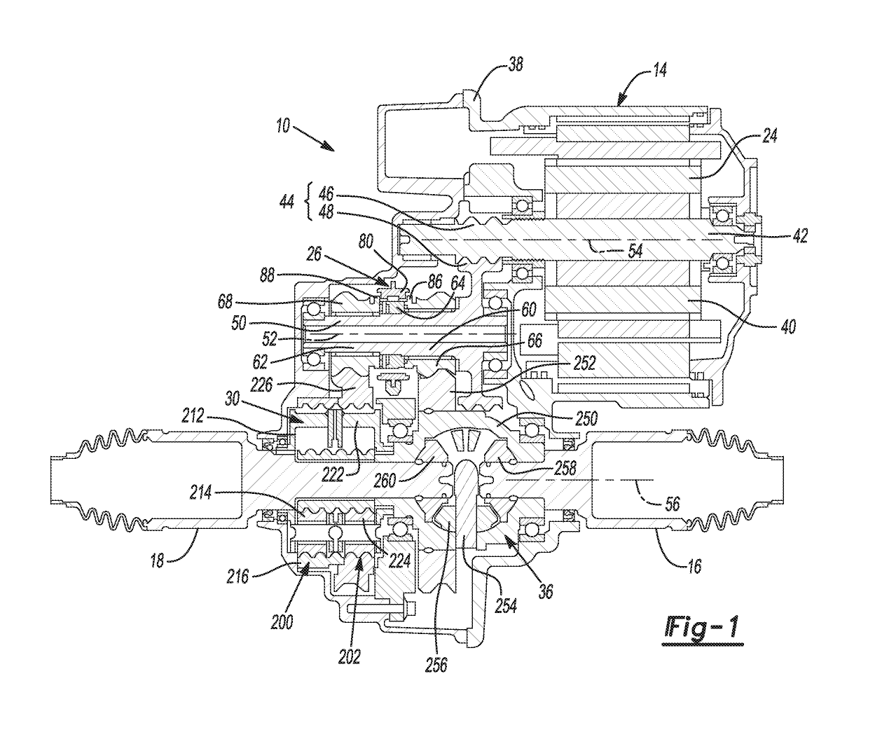

In FIG. 1 of the drawings, a portion of a drive module 10 constructed in accordance with the teachings of the present disclosure is illustrated. Except as noted herein, the drive module 10 can be generally similar to that which is disclosed in commonly assigned, co-pending U.S. patent application Ser. No. 13/835,043 filed Mar. 15, 2013, the disclosure of which is incorporated by reference as if fully set forth in detail herein.

Briefly, the drive module 10 can include a torque distribution drive mechanism 14 that can be employed to transmit torque to first and second output members 16 and 18. The torque distribution drive mechanism 14 can comprise a drive mechanism 24, a power transmitting component or clutch mechanism 26, a dual planetary gear set 30, a differential assembly 36 and a housing 38 into which the drive mechanism 24, the clutch mechanism 26, the dual planetary gear set 30 and the differential assembly 36 can be housed.

The drive mechanism 24 can comprise any type of motor, such as an electric motor 40, and can have an output shaft 42 that can be selectively driven to provide rotary power to a reduction drive 44. The reduction drive 44 can include a first pinion gear 46, which can be mounted to the output shaft 42 for rotation therewith, and a second pinion gear 48 that can be meshingly engaged to the first pinion gear 46 and mounted to an intermediate shaft 50 for common rotation. The intermediate shaft 50 can be disposed along an intermediate axis 52 that is generally parallel to an output shaft axis 54 about which the output shaft 42 of the motor 40 rotates. The intermediate axis 54 can be parallel to an axis 56 about which the differential assembly 36 and the first and second output members 16 and 18 can rotate.

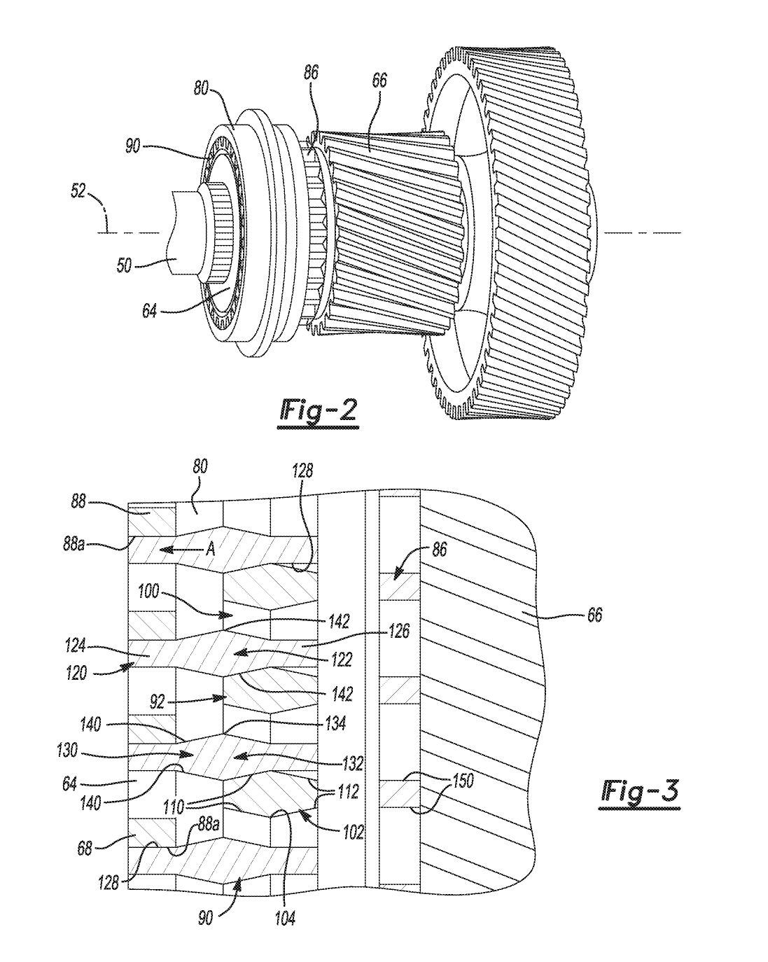

With additional reference to FIG. 2, the intermediate shaft 50 can have a first journal portion 60, a second journal portion 62 and a drive portion 64 that can be disposed between the first and second journal portions 60 and 62. The drive portion 64 can have a plurality of external splines or teeth. A first intermediate output gear 66 can be rotatably received on the first journal portion 60 and a second intermediate output gear 68 can be rotatably received on the second journal portion 62. Bearings (not specifically shown) can be received between the first and second journal portions 60 and 62 and the first and second intermediate output gears 64 and 66, respectively. Thrust bearings (not specifically shown) can be disposed along the length of the intermediate shaft 50 at various locations to help promote relative rotation between the drive portion 64 and the first and second intermediate output gears 64 and 66.

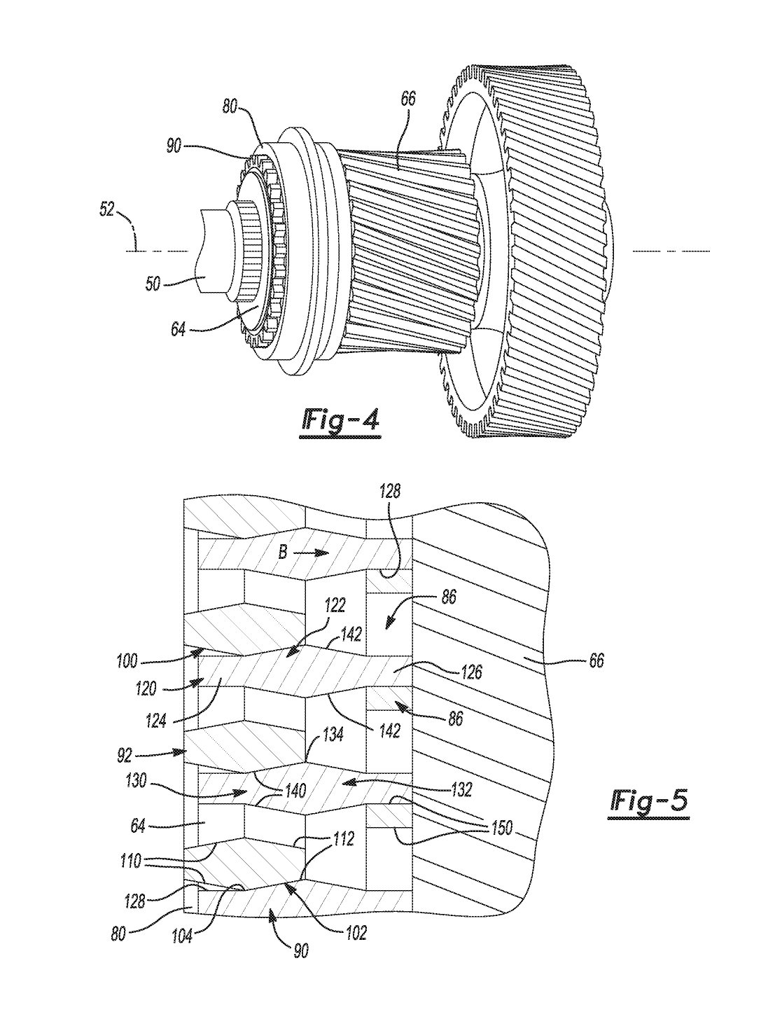

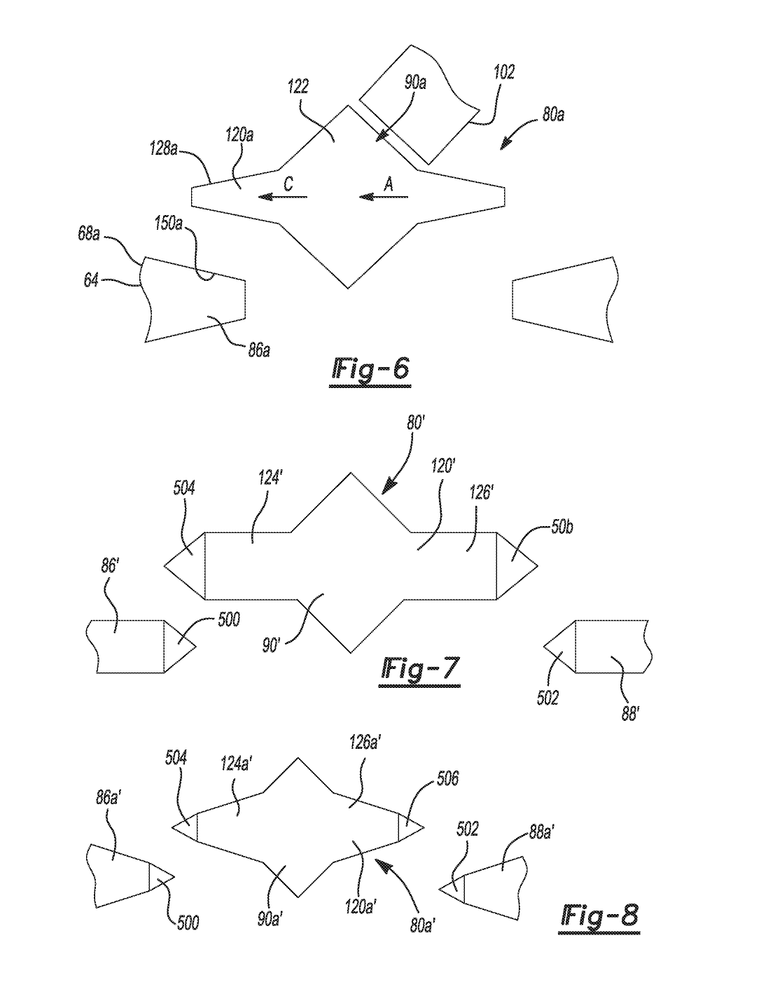

The clutch mechanism 26 can be employed to selectively couple the first intermediate output gear 66 or the second intermediate output gear 68 to the intermediate shaft 50. The clutch mechanism 26 can include a clutch collar 80 having a set of internal teeth that can be meshingly engaged to the external teeth formed on the drive portion 64. Accordingly, rotation of the intermediate shaft 50 will cause corresponding rotation of the clutch collar 80. A first set of clutch teeth 86 can be formed on the first intermediate output gear 66 and a second set of clutch teeth 88 can be formed on the second intermediate output gear 68. The clutch collar 80 can be shifted axially along the intermediate axis 52 between a first position (which is shown in FIG. 6), a second position and a third position (which is shown in FIG. 4). When the clutch collar 80 is positioned in the first position in the particular example provided, the set of internal teeth formed on the clutch collar 80 are engaged with the first set of clutch teeth 86 (to thereby couple the first intermediate output gear 66 to the intermediate shaft 50 for common rotation) and the set of internal teeth formed on the clutch collar 80 are disengaged from the second set of clutch teeth 88 (so that the second intermediate output gear 68 is not coupled to the intermediate shaft 50 for common rotation). When the clutch collar 80 is positioned in the second position in the particular example provided, the set of internal teeth formed on the clutch collar 80 is not engaged to the first or second sets of clutch teeth 86 and 88 so that neither of the first and second intermediate output gears 64 and 66 is coupled to the intermediate shaft 50 for common rotation. When the clutch collar 80 is positioned in the third position in the particular example provided, the set of internal teeth formed on the clutch collar 80 are engaged with the second set of clutch teeth 88 (to thereby couple the second intermediate output gear 68 to the intermediate shaft 50 for common rotation) and the set of internal teeth formed on the clutch collar 80 are disengaged from the first set of clutch teeth 86 (so that the first intermediate output gear 66 is not coupled to the intermediate shaft 50 for common rotation).

With reference to FIGS. 3 and 4, the drive portion 64, the set of internal teeth 90 formed on the clutch collar 80, and the first set of clutch teeth 86 on the first intermediate output gear 66 are shown in more detail. The drive portion 64 can comprise a plurality of first torque-transmitting features or drive teeth 92 having a first engaging portion 100, a second engaging portion 102 and a first transition portion 104 between the first and second engaging portions 100 and 102. The first engaging portion 100 can have first tooth flanks 110 that can be disposed on a first side of the first transition portion 104. The first tooth flanks 110 can diverge from one another with decreasing distance from the first transition portion 104. The second engaging portion 102 can have second tooth flanks 112 that can be disposed on a second, opposite side of the first transition portion 104. The second tooth flanks 112 can diverge from one another with decreasing distance from the first transition portion 104. In the particular example provided, the first and second tooth flanks 110 and 112 are formed by linear/planar segments and the first transition portion 104 comprises points at which the first and second tooth flanks 110 and 112 intersect one another so that each drive tooth 92 is shaped as a rhombus (e.g., has a generally diamond shape). It will be appreciated, however, that other shapes may be employed, including that of a kite, and that the first tooth flanks 110 and/or second tooth flanks 112 can be curved. It will also be appreciated that the first tooth flank 110 on a first side of an associated one of the drive teeth 92 can be formed in a manner that is symmetric to the first tooth flank 110 on the opposite side of the associated one of the drive teeth 92. It will similarly be appreciated that the second tooth flank 112 on the first side of the associated one of the drive teeth 92 can be formed in a manner that is symmetric to the second tooth flank 112 on the opposite side of the associated one of the drive teeth 92. Moreover, the first and second tooth flanks 110 and 112 can be configured such that the second tooth flanks 112 are formed in a manner that is symmetric to the first tooth flanks 110.

Each of the internal teeth 90 on the clutch collar 80 can include a second torque-transmitting feature that can comprise a tooth member 120 and a stop member 122 that can be disposed along the length of the tooth member 120 between first and second axial end portions 124 and 126 of the tooth member 120 (e.g., in the midst of the tooth member 120). Each tooth member 120 can have third tooth flanks 128 that can be parallel to one another and generally parallel to the intermediate axis 52 such that each tooth member 120 has a generally rectangular shape. The stop member 122 can include a third engaging portion 130, a fourth engaging portion 132 and a second transition portion 134. The third engaging portion 130 can have fourth tooth flanks 140 that can be disposed on a first side of the second transition portion 134. The third tooth flanks 128 can diverge from one another with decreasing distance from the second transition portion 134. The fourth engaging portion 132 can have fifth tooth flanks 142 that can be disposed on a second, opposite side of the second transition portion 134. The fifth tooth flanks 142 can diverge from one another with decreasing distance from the second transition portion 134. The fourth tooth flanks 140 can be shaped to cooperate with the second tooth flanks 112 to permit or cause relative rotational movement of the clutch collar 80 when the third engaging portion 130 engages the second engaging portion 102 and the clutch collar 80 is moved in an axial direction (i.e., along the intermediate axis 52) relative to the drive portion 64. Similarly, the fifth tooth flanks 142 can be shaped to cooperate with the first tooth flanks 110 to permit or cause relative rotational movement of the clutch collar 80 when the fourth engaging portion 132 engages the first engaging portion 100 and the clutch collar 80 is moved in an axial direction (i.e., along the intermediate axis 52). In the particular example provided, the fourth and fifth tooth flanks 140 and 142 are formed by linear/planar segments and the second transition portion 134 comprises points at which the fourth and fifth tooth flanks 140 and 152 intersect one another so that each stop member 122 is shaped as a rhombus (e.g., has a generally diamond shape) that is overlaid onto a tooth member 120. It will be appreciated, however, that other shapes may be employed, including that of a kite, and that the fourth tooth flanks 140 and/or fifth tooth flanks 142 can be curved.

Each of the clutch teeth 86 can have sixth tooth flanks 150 that can be disposed parallel to one another and generally parallel to the intermediate axis 52.

The clutch collar 80 can be disposed in the position illustrated in FIGS. 3 and 4 when the first intermediate output gear 66 is to be disengaged from the intermediate shaft 50 and the second intermediate output gear 68 (FIG. 2) is to be engaged to the intermediate shaft 50. In this position, the internal teeth 90 formed on the clutch collar 80 are positioned such that one of the fifth tooth flanks 142 on the stop member 122 of each of the internal teeth 90 abuts one of the first tooth flanks 110 on the first engaging portion 100 of a corresponding one of the drive teeth 92 and one of the flanks 88a on each of the second clutch teeth 88 abuts one of the flanks 128 of the first axial end portion 124 of the tooth member 120 of a corresponding one of the internal teeth 90. The transmission of rotary power between the fifth flanks 142 and the first flanks 110 generates an axially directed force in the direction of arrow A that urges the clutch collar 80 toward the second intermediate output gear 68 along the intermediate axis 52 so as to resist axial movement of the clutch collar 80 along the intermediate axis 52 in a direction that would cause disengagement of the internal teeth 90 on the clutch collar 80 from the second set of clutch teeth 88 on the second intermediate output gear 68 to thereby inhibit unintended disengagement of the clutch collar 80 from the second intermediate output gear 68.

When the first intermediate output gear 66 is to be engaged to the intermediate shaft 50 (for rotation therewith), the clutch collar 80 can be moved along the intermediate axis 52 toward the first intermediate output gear 66 into the position that is shown in FIGS. 5 and 6. In this position, the internal teeth 90 formed on the clutch collar 80 are positioned such that one of the fourth tooth flanks 140 on the stop member 122 of each of the internal teeth 90 abuts one of the second tooth flanks 112 on the second engaging portion 102 of a corresponding one of the drive teeth 92 and one of the flanks 150 on each of the first clutch teeth 86 abuts one of the flanks 128 of the second axial end portion 126 of the tooth member 120 of a corresponding one of the internal teeth 90. The transmission of rotary power between the fourth flanks 140 and the second flanks 112 generates an axially directed force in the direction of arrow B that urges the clutch collar 80 toward the first intermediate output gear 66 along the intermediate axis 52 so as to resist axial movement of the clutch collar 80 along the intermediate axis 52 in a direction that would cause disengagement of the internal teeth 90 on the clutch collar 80 from the first set of clutch teeth 86 on the first intermediate output gear 66 to thereby inhibit unintended disengagement of the clutch collar 80 from the first intermediate output gear 66.

Returning to FIGS. 1 and 2, the dual planetary gear set 30 can include a first planetary gear set 200 and a second planetary gear set 202. The first planetary gear set 200 can include a first sun gear 210, a first planet carrier 212, a plurality of first planet gears 214 and a first ring gear 216, while the second planetary gear set 202 can include a second sun gear 220, a second planet carrier 222, a plurality of second planet gears 224 and a second ring gear 226. The first sun gear 210 can be a hollow structure through which the second output member 18 can be received. The first planet carrier 212 can be rotatable relative to the housing 38 and can be coupled to the output member 18 for common rotation. The first planet carrier 212 can have a plurality of first pins that can journally support the first planet gears 214. The first planet gears 214 can be meshingly engaged to the first sun gear 210 and the first ring gear 216. The first ring gear 216 can be non-rotatably coupled to the housing 38. The second sun gear 220 can be coupled to the first sun gear 210 for common rotation and can be a hollow structure through which the second output member 18 can be received. The second planet carrier 222 can be rotatable relative to the housing 38 and can have a plurality of second pins that can journally support the second planet gears 224. The second planet gears 224 can be meshingly engaged to the second sun gear 220 and the second ring gear 226. The second ring gear 226 can have a set of external teeth that can be meshingly engaged to the second intermediate output gear 68.

The differential assembly 36 can include a differential case 250, a ring gear 252, a cross-pin 254, a plurality of differential pinions 256, and first and second side gears 258 and 260. The differential case 250 can be coupled to the second planet carrier 222 for common rotation. The ring gear 252 can be mounted to the differential case 250 for common rotation and can be meshingly engaged to the first intermediate output gear 66. The cross-pin 254 can be mounted to the differential case 250 perpendicular to the 56. The differential pinions 256 can be journally supported by the cross-pin 254 and meshingly engaged to the first and second side gears 258 and 260. The first output member 16 can be coupled to the first side gear 100 for rotation therewith, and the second output member 18 can be coupled to the second side gear 102 for rotation therewith.

Operation of the clutch mechanism 26 in a first mode (i.e., a propulsion mode) can couple the first intermediate output gear 66 to the intermediate shaft 50 (via the clutch collar 80) to thereby drive the ring gear 252 of the differential assembly 36. As will be appreciated, rotation of the ring gear 252 drive the differential carrier 250 and the cross-pin 254 for rotation about the axis 56, driving the differential pinions 256 to cause corresponding rotation of the first and second side gears 258 and 260. In this mode, the dual planetary gear set 30 does not affect operation of the differential assembly 36 and as such, the differential assembly 36 provides rotary power to the first and second output members 16 and 18 in the manner of a standard open differential assembly.

Operation of the clutch mechanism 26 in a second mode (i.e., a torque vectoring mode) can couple the second intermediate output gear 68 to the intermediate shaft 50 (via the clutch collar 80) to thereby drive the second ring gear 226 of the dual planetary transmission 30. In this embodiment, rotary power is output from the second planetary gearset 202 to the differential carrier 250 (via the second planet carrier 222) and rotary power is output from the first planetary gearset 200 to the second output member 18 (via the first planet carrier 212). As the second output member 18 is non-rotatably coupled to the second side gear 260, it will be appreciated that the first planet carrier 212 is also drivingly coupled to the second side gear 260. Those of skill in the art will appreciate from this disclosure that the dual planetary transmission 30 can be employed to impose equal but opposite moments on the first and second output members 16 and 18 and that the direction of the rotary power (torque) that is applied to a given one of the output members is dependent upon the direction in which the motor 40 is operated.

While the clutch has been illustrated and described as including a clutch collar having teeth with flat flanks that drivingly engage the flat flanks of teeth on an output gear so that a locking force is generated solely between a drive portion and the clutch collar, those of skill in the art will appreciate that the clutch could be configured somewhat differently. With reference to FIG. 7 for example, the tooth member 120a of the internal teeth 90a on the clutch collar 80a can be configured such that the third flanks 128a taper inwardly toward one another with increasing distance away from the stop member 122, while the sixth flanks 150a on the first clutch teeth 86a on the first intermediate output gear 68a are tapered in a similar but mirrored (opposite) manner (i.e., the flanks 150a on the first clutch teeth 86a taper inwardly toward one another with decreasing distance toward the drive member 64). The transmission of rotary power between the third flanks 128a and the sixth flanks 150a generates an axially directed force in the direction of arrow C that urges the clutch collar 80a toward the first intermediate output gear 66a along the intermediate axis 52 so as to resist axial movement of the clutch collar 80a along the intermediate axis 52 in a direction that would cause disengagement of the internal teeth 90a on the clutch collar 80 from the first set of clutch teeth 86a on the first intermediate output gear 66a to thereby inhibit unintended disengagement of the clutch collar 80a from the first intermediate output gear 66a.

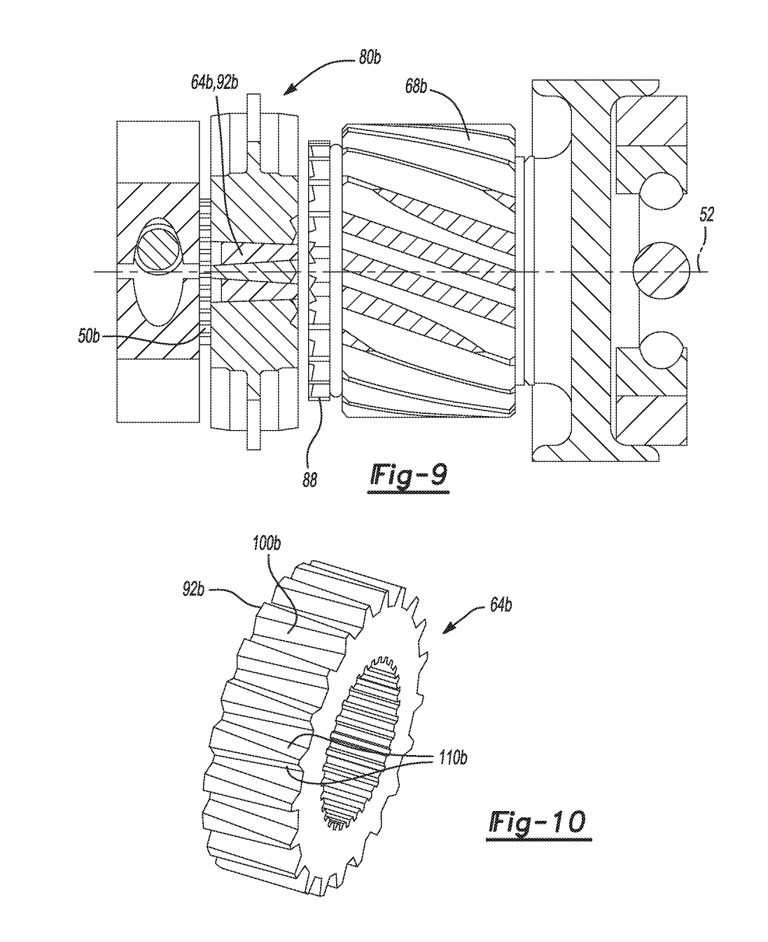

Those of skill in the art will further appreciate that the tips of the first clutch teeth, the tips of the second clutch teeth and/or one or both of the opposite tips of the internal teeth can be configured to help to align the internal teeth of the clutch collar to the first or second intermediate output gear. In the example of FIGS. 8 and 9, each of the tips 500 of the first clutch teeth 86′ and 86a′, each of the tips 502 of the second clutch teeth 88′ and 88a′, and each of the tips 504 of the first axial ends 124′ and 124a′ and each of the tips 506 of the second axial ends 126′ and 126a′ of the tooth members 120′ and 120a′, respectively, of the internal teeth 90′ and 90a′ can be tapered or pointed to help cause relative rotation of the clutch collar 80′ and 80a′ to prevent or minimize gear clash when moving the clutch collar between the first and third positions.

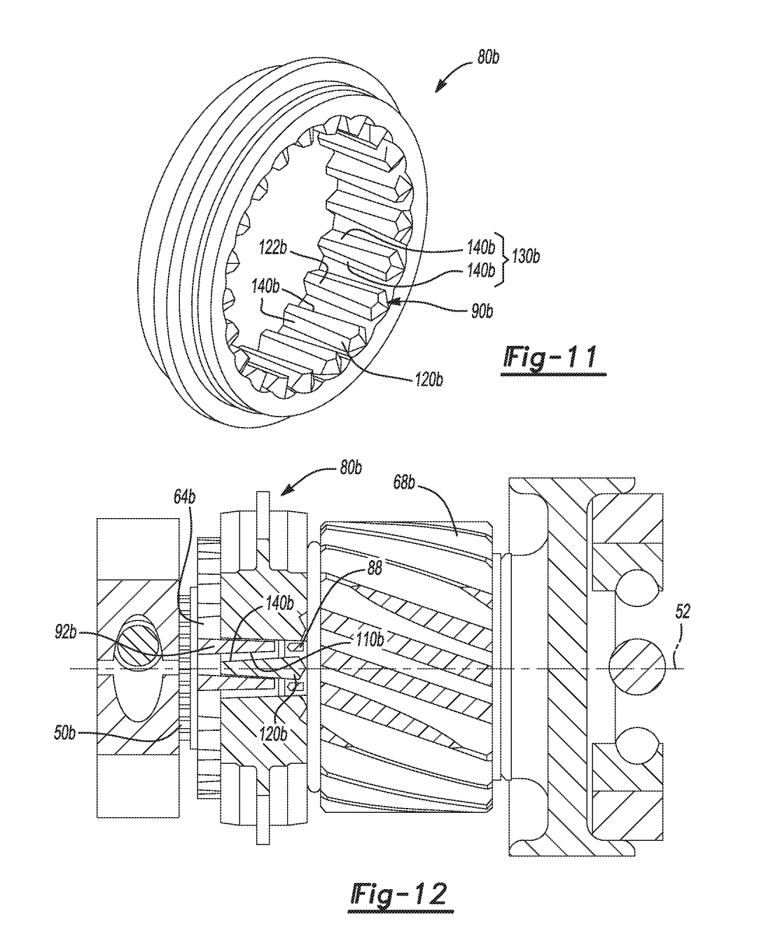

While the clutch has been illustrated and described as including a clutch collar that is positionable in two driving positions (i.e., first and third positions) and whose teeth are configured to resist motion of the clutch collar in from driving position toward the other driving position, those of skill in the art will appreciate that the clutch could be configured somewhat differently. With reference to FIGS. 9 through 12, the clutch collar 80b is movable along the intermediate axis 52 between a first position (shown in FIG. 12) and a second position (shown in FIG. 9).

The drive portion 64b of the intermediate shaft 50b has a plurality of first teeth 92b, each of which having a first engaging portion 100. A single intermediate output gear 68b is employed in this example and is rotatably received on the intermediate shaft 50b in a manner that is similar to that which is described above. The intermediate output gear 68b has a plurality of second teeth 88 (FIG. 12).

The clutch collar 80b has a plurality of clutch teeth 90b, each of which having a tooth member 120b and a stop member 122b that are integrally formed with one another. Each stop member 122b has a second engaging portion 130b having a second flank 140b that extends further from a midpoint of a corresponding one of the clutch teeth 90b with decreasing distance to the tooth member 120b. Each first engaging portion 100b has a first flank 110b that extends further from a midpoint of an associated one of the first teeth 92b with decreasing distance to the intermediate output gear 68b. When the clutch collar 80b is in the first position, the first flanks 110b of the first engaging portions 100b engage the second flanks 140b of the second engaging portions 130b and the tooth members 120b are engaged to the second teeth 88b to thereby transmit rotary power between the drive portion 64b, the clutch collar 80b and the intermediate output gear 68b. The first and second flanks 110b and 140b cooperate to resist movement of the clutch collar 80b in a direction away from the intermediate output gear 68b. Each clutch tooth 90b can have a longitudinal axis and each of the clutch teeth 90b can be symmetrical about its longitudinal axis.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A power transmitting component comprising:
a first rotary member having a plurality of first teeth, the first teeth having a first engaging portion, a second engaging portion, and a first transition portion between the first and second engaging portions, each first engaging portion having a first flank that extends further from a midpoint of a corresponding one of the first teeth with decreasing distance to the first transition portion, each second engaging portion having a second flank that extends further from a midpoint of an associated one of the first teeth with decreasing distance to the first transition portion;
a second rotary member having a plurality of second teeth, and a first end stop;
a third rotary member having a plurality of third teeth and a second end stop; and
a clutch collar having a plurality of clutch teeth, each clutch tooth having a tooth member and a stop member that are integrally formed with one another, each stop member having a third engaging portion, a fourth engaging portion and a second transition portion between the third and fourth engaging portions, each third engaging portion having a third flank that extends further from a midpoint of a corresponding one of the clutch teeth with decreasing distance to the second transition portion, each fourth engaging portion having a fourth flank that extends further from a midpoint of an associated one of the clutch teeth with decreasing distance to the second transition portion;
wherein the clutch collar is movable between a first position, a second position and a third position, wherein when the clutch collar is in the first position, the second flanks of the second engaging portions engage the third flanks of the third engaging portions and the tooth members are engaged to the second teeth to thereby transmit rotary power between the first rotary member, the clutch collar and the second rotary member, the second and third flanks cooperating to resist movement of the clutch collar in a direction away from the second rotary member, and the first end stop abuts the tooth members to inhibit movement of the clutch collar in a direction toward the second rotary member, wherein when the clutch collar is in the third position, the first flanks of the first engaging portions engage the fourth flanks of the fourth engaging portions and the tooth members are engaged to the third teeth to thereby transmit rotary power between the first rotary member, the clutch collar and the third rotary member, the first and fourth flanks cooperating to resist movement of the clutch collar in a direction away from the first rotary member, and the second end stop abuts the tooth members to inhibit movement of the clutch collar in a direction toward the first rotary member, and wherein when the clutch collar is in the second position, the clutch teeth are not engaged to the second or third teeth.

2. The power transmitting component of claim 1, wherein the first flanks taper toward the first transition portion.

3. The power transmitting component of claim 2, wherein the fourth flanks taper toward the second transition portion.

4. The power transmitting component of claim 1, wherein the second flanks taper toward the first transition portion.

5. The power transmitting component of claim 4, wherein the third flanks taper toward the second transition portion.

6. The power transmitting component of claim 1, wherein the first teeth are diamond shaped.

7. The power transmitting component of claim 6, wherein the stop members are diamond shaped.

8. The power transmitting component of claim 1, wherein when the clutch collar is in the second position, the second transition portions contact the first transition portions.

9. The power transmitting component of claim 1, wherein portions of each of the tooth members extend from opposite axial sides of a corresponding one of the stop members.

10. A power transmitting component comprising:
a first rotary member having a plurality of first teeth, each of the first teeth having a first engaging portion and a first transition portion adjacent to the first engaging portion, each first engaging portion having a first flank that extends further from a midpoint of a corresponding one of the first teeth with decreasing distance to the first transition portion;
a second rotary member having a plurality of second teeth and a first end stop; and
a clutch collar having a plurality of clutch teeth, each clutch tooth having a tooth member and a stop member that are integrally formed with one another, each stop member having a second engaging portion and a second transition portion adjacent to the second engaging portion, each second engaging portion having a second flank that extends further from a midpoint of a corresponding one of the clutch teeth with decreasing distance to the second transition portion;
wherein the clutch collar is movable between a first position and a second position, wherein when the clutch collar is in the first position, the first flanks of the first engaging portions engage the second flanks of the second engaging portions and the tooth members are engaged to the second teeth to thereby transmit rotary power between the first rotary member, the clutch collar and the second rotary member, the first and second flanks cooperating to resist movement of the clutch collar in a direction away from the second rotary member, the first end stop abutting a terminal end of the tooth members to inhibit movement of the clutch collar in a direction toward the second rotary member, and wherein when the clutch collar is in the second position, the clutch teeth are not engaged to the second teeth.

11. The power transmitting component of claim 10, wherein the first flanks taper toward the first transition portion.

12. The power transmitting component of claim 11, wherein the second flanks taper toward the second transition portion.

13. The power transmitting component of claim 10, wherein the first teeth are diamond shaped.

14. The power transmitting component of claim 13, wherein the stop members are diamond shaped.

15. The power transmitting component of claim 10, wherein when the clutch collar is in the second position, the second transition portions contact the first transition portions.

16. The power transmitting component of claim 10, wherein portions of each of the tooth members extend from opposite axial sides of a corresponding one of the stop members.

17. A power transmitting component comprising:
a first rotary member having a plurality of first teeth, the first teeth having a first engaging portion,
a second rotary member having a plurality of second teeth and a first end stop; and
a clutch collar having a plurality of clutch teeth, each clutch tooth having a tooth member and a stop member that are integrally formed with one another, each stop member having a second engaging portion, each second engaging portion having a second flank that extends further from a midpoint of a corresponding one of the clutch teeth with decreasing distance to the tooth member;
wherein each first engaging portion has a first flank that extends further from a midpoint of an associated one of the first teeth with decreasing distance to the second rotary member;
wherein the clutch collar is movable between a first position and a second position; and
wherein when the clutch collar is in the first position, the first flanks of the first engaging portions engage the second flanks of the second engaging portions and the tooth members are engaged to the second teeth to thereby transmit rotary power between the first rotary member, the clutch collar and the second rotary member, the first and second flanks cooperate to resist movement of the clutch collar in a direction away from the second rotary member, the first end stop abutting the tooth members to inhibit movement of the clutch collar in a direction toward the second rotary member.

18. The power transmitting component of claim 17, wherein each clutch tooth has a longitudinal axis and wherein each of the clutch teeth is symmetrical about its longitudinal axis.
